(19) United States
(12) Patent Application Publication
(10) Pub. No.: US 2016/0015217 A1
(43) Pub. Date: Jan. 21, 2016

(54) BLENDER JAR, BLENDER BASE UNIT AND BLENDER

(71) Applicant: AKTIEBOLAGET ELECTROLUX, Stockholm (SE)

(72) Inventors: Monica Rojas Restrepo, Stockholm (SE); Johann Zita, Stockholm (SE); Brian Vines, Stockholm (SE)

(21) Appl. No.: 14/441,596

(22) PCT Filed: Apr. 3, 2013
(86) PCT No.: PCT/EP2013/057041

§ 371 Date: May 8, 2015

(51) Int. Cl. A47J 43/046

(52) U.S. Cl. CPC A47J 43/046

(57) ABSTRACT

A blender jar for a household type blender. The blender includes a jar and a blender blade assembly provided rotatably around a rotary axis at a bottom of the blender jar. The rotary axis is tilted from a normal axis of a working surface used for operating the blender jar thereon in ordinary use, and the bottom of the blender jar at which the blender blade assembly is positioned has a flat surface configuration.

The present invention is directed to a blender jar for a household type blender, a corresponding blender base unit and blender of household type.

Current household or domestic blenders or mixers in the market need to deal with different ingredients and recipes and be capable of liquefying, mixing and producing different textures. In most of cases, the performance of the blenders is measured in the final particle size after processing during a certain period of time.

Therefore, the circulation inside the blender jar and the efficiency of the blades has a lot to do with achieving good results. One of the most difficult tasks when processing food in the blender or blender jar is having to process viscous ingredients or recipes, such as smoothies, milkshakes or slushies, because the circulating movement is reduced, and the demand of power and efficiency from the motor and blades is increased. The viscosity of such ingredients also reduces the suction carried by the vortex, and an air pocket can be formed above the blades, causing them to spin without processing nearby food.

To avoid the formation of air pockets and to enhance the circulating movement, it is known to use plungers by which the user can interact in a stirring movement and thus help to explode or remove the air pocket and to re-establish adequate circulating movement.

Further it is known to avoid or remove air pockets and enhance the circulating movement by improving the suction in the vortex, which can be obtained by increasing the speed of the blender blades or by adding more liquid to the mixture.

The aforementioned solutions bring unconformities to the user as in the first case, the user needs to intervene. In the second case, where in most cases rotational speeds of over 20,000 rpm are used, comparatively high noise levels, that are generally difficult to remove, are generated. And the third case the final result could be affected in quality of textures and flavour due to the addition of more liquid.

In U.S. Pat. No. 7,217,028 B2 a domestic blender with a tilted blender jar is described, wherein tilting the blender jar is thought to improve mixing and blending results.

Another issue identified on the performance of known domestic blenders for example is the formation of ice bridges below the blender blade during processing frozen items, such as ice cubes. In general this issue relates to the aggregation of particulate matter below the blender blade during operation.

As can readily be seen, there is still need for improving blending or mixing results and vortex generation of domestic blenders.

It is one of the objects of the present invention to solve the inconveniences observed with state of technology. In particular, it is an object of the invention to provide solutions for achieving improved blending, mixing and vortex generation in blender jars of domestic or household type blenders. In particular, a respective blender jar for a household type blender, blender base unit for a household type blender and blender of household or domestic type shall be provided.

This object is solved by claims 1, 10 and 12. Embodiments result from respective dependent claims.

According to claim 1, a blender jar for a household or domestic type blender, in particular a household or domestic type blender jar, is provided. The blender jar comprises a blender blade assembly, in particular at least one blender blade, which is attached rotatably around a rotary axis at a bottom of the blender jar. With the proposed blender jar, the rotary axis is tilted from a normal or perpendicular axis of a working surface used for operating the blender jar thereon in or during ordinary use.

The normal axis of the working surface in particular shall correspond to the surface-normal of a respective working surface. In case that the blender in normal or ordinary operation is positioned or placed on a horizontal working surface, which probably in most cases applies, the rotary axis is and will be tilted against the vertical direction.

It shall be noted, that the term “jar” in the sense of the present application in particular shall cover the terms “goblet”, “jug” or “container”. A blender jar in the sense of the present application in particular may be implemented as a portable type jar adapted to be manually operable, usable or handleable by a user. In particular, the jar may be adapted such that it can be removably placed or arranged on a corresponding blender base in a manual action of the user.

The tilt angle of the rotary axis may in particular be selected in dependence of a geometrical parameter of the blender jar. Such parameters are for example the diameter of the blender jar, in particular at a bottom, mid or upper section, the shape of the blender jar bottom, the shape of the blender jar side walls, the cross-sectional shape of the blender jar etc.

In one variant, it may be provided that the tilt angle of the rotary axis is adjustable within a certain angular range. In this variant, the tilt angle may be adjusted to the kind of ingredients to be processed within the blender jar.

It has been found out, that tilting the rotary axis leads to enhanced mixing and blending in ordinary operation of a respective blender. In particular, improved circulation movement and vortex generation within the blender jar can be obtained. Further, aggregation of particulate matter below the bender blade, in particular the formation of ice bridges, as well as air pockets can greatly be avoided. Therefore, processing of comestible goods and substances, such as foodstuff, beverages and/or comestible ingredients intended for preparing dishes, foodstuff and/or beverages and the like, can be greatly enhanced.

With a tilted arrangement of the rotary axis as proposed herein, it is further possible to improve the performance at lower rotational speeds of the blender blade, in particular due to the fact that the recirculation and circulating movement within the blender jar is improved. This in particular means that in the same amount of time, more ingredients reach the blades as compared to a non-tilted arrangement of the rotary axis.

Here, it shall be mentioned that the improvements in mixing, blending and circulating movement may be based on the combined action of the tilted drag and lift forces generated by the tilted blender blade and gravitational forces acting in vertical direction upon the substances, in particular comestible substances, within the blender jar.

According to an embodiment of the blender jar, it is advantageous to use a tilt angle by which the rotary axis is tilted from the normal axis in the range from 5 degrees to 20 degrees. The mentioned range of possible tilt angles has been proven optimal for obtaining excellent mixing and circulating movements for liquid, viscous and/or hard food-type ingredients.

In a further embodiment, a central axis of inner walls of the blender jar, i.e. a central axis of the blender jar, and the rotary axis are tilted from each other by an acute angle. The acute angle may lie in the range from 0 degrees to 20 degrees, in particular from 1 degree to 20 degrees. However, it is also possible, that the central axis and the rotary axis are aligned with each other, i.e. oriented collinear. In addition, the central axis of the blender jar and the rotary axis may be offset from each other, in particular relative to a plane parallel to the working surface.

Tilting the blender jar relative to the rotary axis may be used to optimize mixing and circulating movements for different blender jar geometries.

The angle by which the blender jar is tilted against the rotary axis may for example be selected in dependence of a geometrical parameter of the blender jar or respective blender jar walls, in particular but not restricted to diameter of the blender jar, cross-sectional shape of the blender jar and the like. Reference is made to corresponding parameters listed further above in connection with the tilt angle of the rotary axis, which are also applicable in the present case.

In a yet further embodiment, the bottom of the blender jar at which the blender blade is positioned has a rounded, in particular spherical, preferably semi-spherical, configuration or shape. Using such bottom geometries has been proven advantageous for obtaining optimal circulation movement in particular within, into and out of the blender jar bottom region in which the blender blade acts upon the ingredients. Advantageously, aggregation of particulate matter below the blender blade can be greatly avoided. The combination of tilting the blender jar relative to the rotary axis together with a rounded bottom geometry of the blender jar has been proven beneficial to the performance of the blender. This combination minimizes the risk of any material or foodstuff being stuck or not being sufficiently circulated in the jar. Accordingly, the mixing performance shows satisfactory results and the power consumption and noise level are at the same time kept at low levels.

In another embodiment, the bottom of the blender jar at which the blender blade assembly is positioned has a flat surface area below the rotatable blades. Using a substantially flat bottom geometry has also proven advantageous for obtaining optimal cutting results. Using a flat bottom geometry lowers the risk and possibility for ingredients being prepared in the blender to get stuck and thereby not properly processed. The combination of a flat bottom geometry together with the tilting of the blender jar relative to the rotary axis is advantageous for the performance of the blender as the tilt further reinforces the effect of all material being processed in the blender.

In an embodiment of the blender jar, a blender blade of the blender blade assembly has a trough-shaped vertical cross section. Such a shape in particular is advantageous for generating optimal circulating movements in blender jars having rounded, in particular spherical or semi-spherical bottom shapes.

In another embodiment of the blender jar, a blender blade of the blender blade assembly may be a curved shaped (C-shaped) flat blade. In use, the blade is parallel to the bottom surface of the blender jar. Such a C-shaped blade adds a chopping level to the blades assembly. In particular in relation to the flat bottom geometry of the blender jar, such a C-shaped blade enhances the final residue, i.e. the result of the mixed ingredients.

Also in an embodiment, the C-shaped blade is combined with a trough-shaped blade forming a blade assembly having at least two blades.

In particular with the C-shaped blender blade it may be provided that the blender blade has two blade arms respectively comprising in successive arrangement a base section, a flat outwardly reaching curve shaped blade being sharpened at the top. The two C-shaped blade arms together form a S-shaped blender blade.

In particular with the trough-shaped blender blade it may be provided that the blender blade has two arms respectively comprising in successive arrangement a base section, a wing section, angled upwards from the base section, and a winglet section provided at a distal end of the wing section. The wing section may be twisted for obtaining an adequate angle of attack.

The proposed blender blade geometry is of particular advantage for blender jar bottom shapes as mentioned above. Further, the blender blade shape and configuration are effective in generating optimal mixing and blending results and circulating movement with the tilted blender blade rotary axis.

In an embodiment, side walls of the blender jar are inclined against the central axis of the blender jar, in particular such that a cross section of the blender jar decreases towards the bottom of the blender jar. In this way, a funnel-shaped blender jar configuration can be obtained, which has proven optimal for tilted blender blade arrangements. In particular, the funnel-shaped blender jar facilitates optimal circulating movement and vortex generation.

In a yet further embodiment, the blender jar comprises a coupling interface adapted to couple the blender jar and blender blade assembly to a motorized base unit. It is provided that the coupling interface is adapted to be coupled to the motorized base unit at an angle from above. In particular, the coupling interface may be inclined to take account of the tilt arrangement of the rotary axis of the blender blade assembly. With the proposed geometry the blender jar can be put on or be coupled to the base unit in a movement, in particular a manual action of a user, directed diagonally downwards. Removing the blender jar from the base unit can be done in a movement diagonally upwards, preferably also in a manual action of a user.

Preferably, in coupling the blender jar to the base unit, a connection or connecting engagement between the blender blade assembly, in particular blender blade, and a drive shaft of a motor of the motorized base is automatically established.

Providing the interface as proposed above is an efficient way to implement a tilted rotary axis of the blender blade. In particular the drive shaft for the blender blade can be provided in a tilted arrangement in accordance with the tilt angle of the rotary axis, such that no gear or other transmission is required between the drive shaft and rotary axis.

According to claim 10, a blender base unit for a household type blender, is provided which comprises a motor for driving a blender blade assembly of a blender jar having a coupling interface, wherein the blender jar is implemented as described above. The blender base unit may be implemented as part of a moveable type domestic blender or mixer. As mentioned already above, the blender jar may be implemented to be handled manually by a user.

The proposed blender base unit comprises a coupling counter-interface which is adapted to be removably coupled, in particular in a manual user action, to the coupling interface of the blender jar. Preferably, the counter-interface is adapted to releasably latch the coupling interface of the blender jar in a downward movement at an angle from above. The counter-interface in particular may be inclined in accordance with the tilt angle of the rotary axis of the blender blade assembly and/or according the corresponding inclination of the coupling interface of the blender jar. This in particular means that the blender jar can be put on or coupled to the blender base in a movement directed diagonally downwards. Simultaneously to coupling the blender base and blender jar together, a drive shaft connected to a drive motor of the blender base may be coupled to the blender blade such that the blender blade can be rotated by the drive motor.

Regarding the proposed counter-interface, which may comprise for example a cylindrical connection portion, a normal axis of the counter interface, preferably is tilted with respect to the normal axis of the working surface in accordance with the tilt angle of the rotary axis. As to advantages, reference is made to the description above, in particular related to the blender jar comprising a corresponding coupling interface.

According to claim 12, a household or domestic type blender, in particular a mixer, is provided which comprises a blender jar as described above and further above, including any embodiment and variant of the blender jar. The blender further comprises a blender base unit as described above. In accordance to the description above, the blender, blender jar and blender base unit are preferably implemented as a moveable domestic or household device, in which the blender jar and blender base unit advantageously are implemented to be removably or releasably coupled to or latched with each other. As to advantages and advantageous effects of the blender, which may also be designated as mixer, reference is made to the description above and further below.

Embodiments of the invention will now be described in connection with the annexed figures, in which.

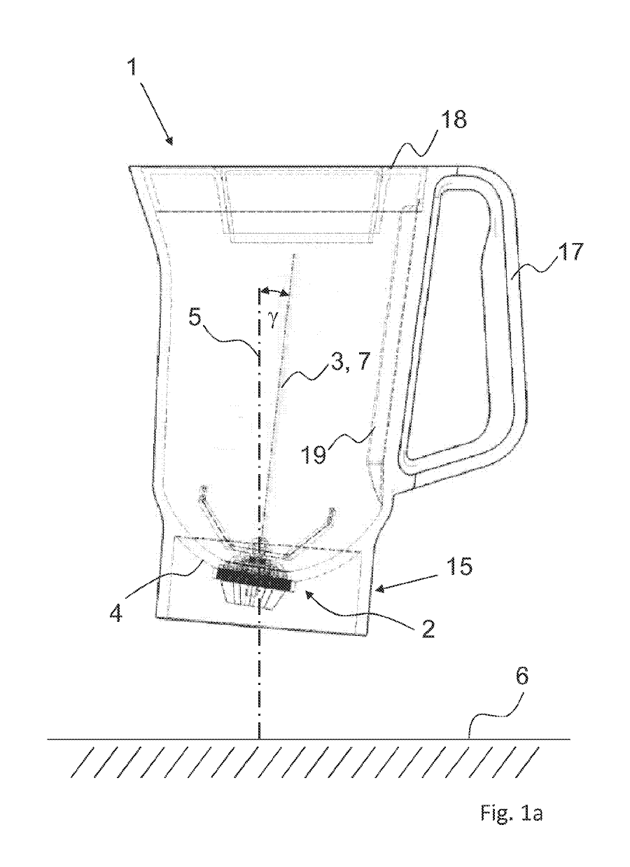

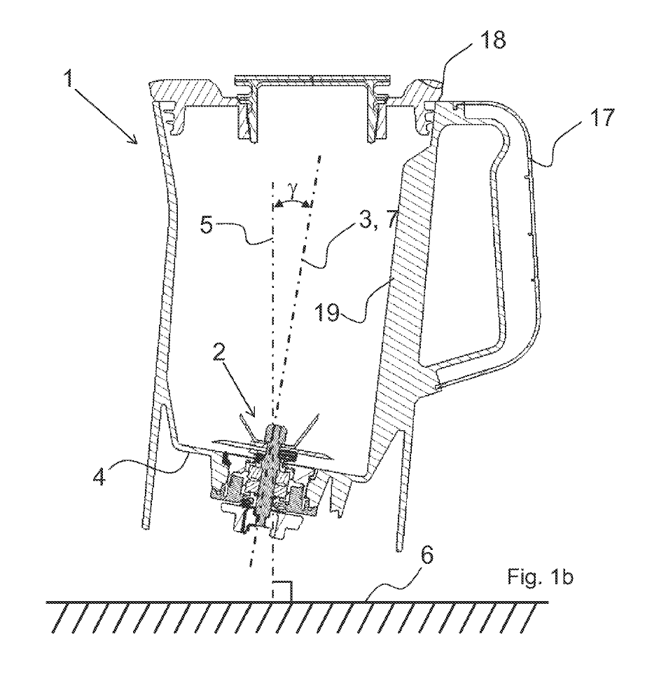

FIG. 1a schematically shows a broken-up side view of a blender jar;

FIG. 1b schematically shows a broken-up side view of a blender jar of another embodiment;

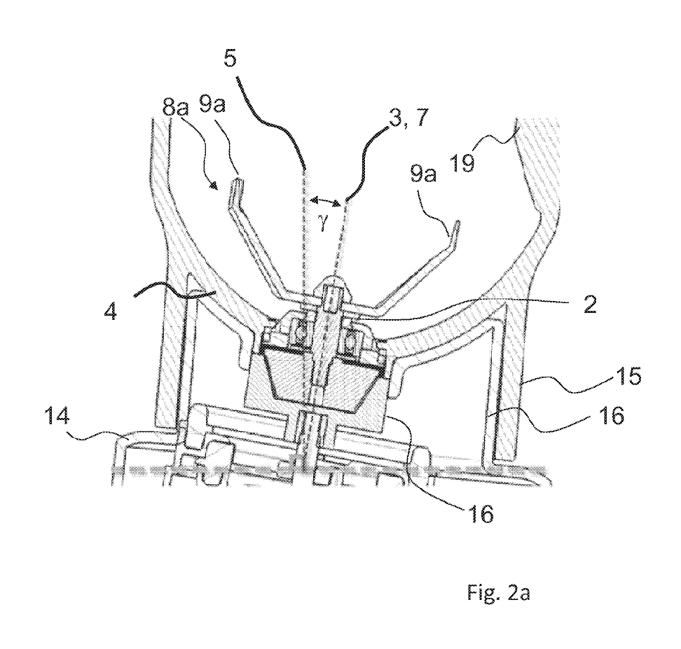

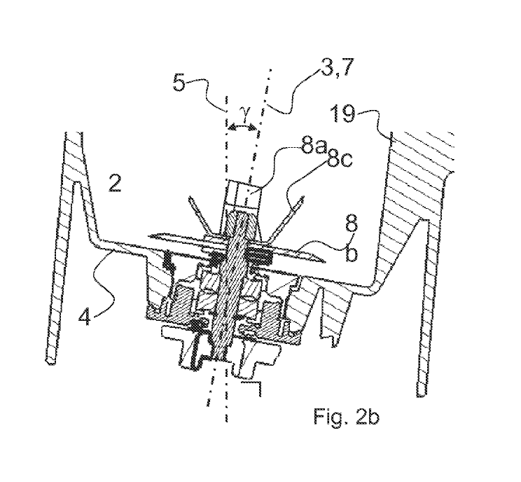

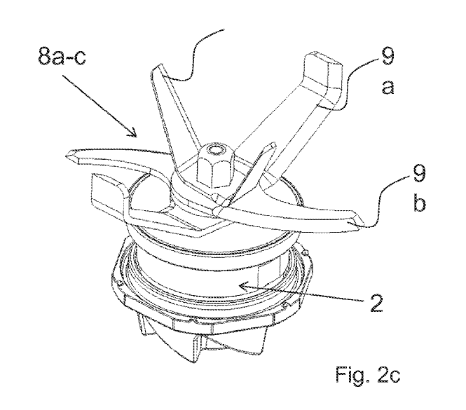

FIG. 2a shows a detail of the blender jar according to FIG. 1a;

FIG. 2b shows a detail of the blender jar according to the embodiment in FIG. 1b,

FIG. 2c shows an enlarged view of the blade assembly for the embodiment illustrated in FIGS. 1b and 2b, and

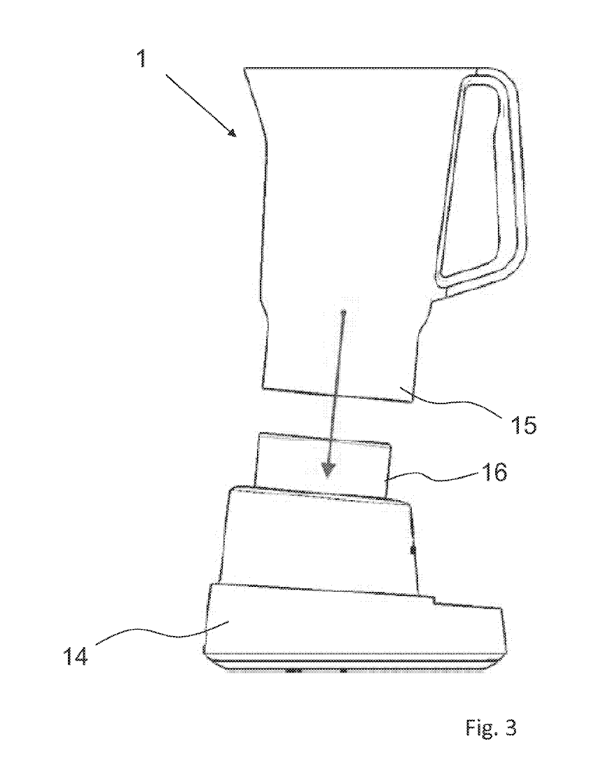

FIG. 3 shows a blender jar and a corresponding blender base unit.

Unless otherwise mentioned, like elements are designated by like reference signs throughout the figures.

FIGS. 1a and 1b show a blender jar 1 of a domestic blender or mixer, comprising a blender blade assembly 2. The blender blade assembly 2 is attached, rotatable around a rotary axis 3, to the bottom 4 of the blender jar 1.

The blender jar 1 is implemented as a handheld-type device, i.e. the blender jar 1 is manually handleable by a user. For manual handling or operation of the blender jar 1, it is provided that the blender jar 1 comprises a handle 17, which may for example be an integrated part of the blender jar 1.

The blender jar 1 as in particular shown in FIGS. 1a and 1b is implemented as a type of container or vessel which is open at one end, in more detail, which has an axial opening at one axial end. The axial opening in the present case is arranged oppositely to the bottom 4. The blender jar 1 may comprise a lid 18 for covering or closing the axial opening. The lid may be hingedly or removeably attached to a base body of the blender jar 1. The blender jar 1 may also be provided with at least one rib 19 on the inside wall. The purpose of the rib 19 is to enhance the mixing properties as well as minimizing the dead zones in the blender jar, i.e. areas where material or particles may be stuck.

As can be seen from FIGS. 1a and 1b, in which the blender jar 1 is depicted in the orientation during ordinary operation, the rotary axis 3 of the blender blade assembly 2 is tilted from a normal axis 5 of a working surface 6 on which the blender jar 1 may and will be operated in ordinary use.

In general and in most cases, the working surface 6 will be represented by a horizontal plate or surface. In this case, the normal axis 5 is parallel to the vertical direction. However, using the term “normal axis of a working surface” shall account for the possibility that a respective working surface may be inclined, in particular slightly inclined, to the horizontal direction.

It has been found out that tilting the rotary axis 5 of the blender blade assembly 2 will lead to improved mixing and blending results. Further, better performance in mixing and blending can be obtained, in particular at lower rotational speeds of the blender blade.

The tilt angle γ, by which the rotary axis 3 of the blender blade or blender blade assembly 2 is tilted from the normal axis 5 lies in the range from 5 degrees to 20 degrees. Such angles have been identified to be advantageous for obtaining optimal mixing and blending as well as circulating movement within the blender jar 1.

In the present embodiments according to FIGS. 1a and 1b, a central axis 7 of the blender jar 1 essentially coincides with the rotary axis 3, i.e. the central axis 7 and rotary axis 3 are aligned.

However, in variants of the blender jar 1 the central axis 7 of the blender jar 1 and the rotary axis 3 may be misaligned, in particular tilted against each other.

In other variants, it is possible that the central axis 7 and the rotary axis 3 are displaced from each other. This in particular shall include variants, in which the blender blade assembly 2 is not centred within the blender jar 1.

Note, that in the present embodiments as depicted in FIGS. 1a and 1b, the blender blade assembly 2 is positioned and arranged centred within the blender jar 1.

A centred arrangement of the blender blade assembly 2, at least in the bottom region, in particular is advantageous for blender jars 1 having a flat bottom area or a rounded or spherical bottom area 4, as is the case with the present embodiments.

Details related to the blender jar bottom 4 and the tilt angle γ can be seen in FIGS. 2a and 2b showing an enlarged section of the blender jar 1 of FIGS. 1a and 1b. In particular it can be seen in FIGS. 2a and 2b that the blender blade assembly 2 is centred within the blender jar 1, in particular centred within the bottom section of the blender jar 1.

With further reference to FIG. 2a, it can be seen that a blender blade 8a of the blender blade assembly 2 has a trough-shaped vertical cross section. The blade assembly of this embodiment comprises a single blender blade 8a as shown in FIG. 2a having two blade arms 9a. Each blade arm 9a comprises in a successive arrangement a base section, a wing section angled upwards from the base section, and a winglet section provided at a distal end of the wing section.

The proposed blender blade shape 8a and design in relation to FIG. 2a are of particular advantage for rounded and spherical bottom structures and shapes of the blender jar 1. The proposed blender blade 8a is effective in generating adequate and sufficient drag and lift forces to optimally mix and circulate ingredients within the blender jar.

The trough-shaped cross section of the blender blade 8a also has the advantage that the variations in the distances between the blender blade 8a and the bottom wall 4 of the blender jar 1 can be minimized or at least kept in a comparatively narrow range. This may inter alia lead to enhanced vortex generation and mixing.

FIG. 2b illustrates a blade assembly 2 having at least one additional blade added to the blender blade 8a, which consist of a curved shaped (C-shaped) blade 8b. The C-shaped blade 8b comprises two blade arms 9b that helps swiping the flat bottom of the blender jar in accordance with this embodiment. In this way, possible residue stuck in the corners are reduced and integrated back to the vortex. The C-shaped blade 8b describes a curved shape and is parallel to the bottom surface of the blender jar. The C-shaped blade is sharpened on top. Details of the blade assembly arranged in the embodiment illustrated in FIGS. 1b and 2b may be seen in FIG. 2c. A first C-shaped blade can be attached on the same level to a second C-shaped blade (forming a S-shaped blade) or one on top of the other which adds two different chopping levels for enhancing the final residue.

In addition, a rib 19 in one of the sides of the blender jar reaches downwardly from the opening of the blender jar towards the flat bottom surface, and works in conjunction with the C-blades. The curved shape is beneficial in guiding big pieces stuck on the bottom surface of the jar, to be guided to the end and closer to the walls of the jar. This increases the opportunities for the pieces of returning back to the vortex or to be sliced when close to jar walls and the rib. The distance between the tip of the C-blade and the rib is reduced, which may help in slicing ingredients that may be stuck in the blade or in the corners of the blender jar.

In FIG. 2b it is also shown a further blade 8c among the blades in the blades assembly 2. An additional blender blade 8c may be added, in the cases where the blender jar 1 has a wide bottom. The additional blade 8c may be added on top of the trough-shaped blade 8a and the C-shaped blade 8b to cover the centre of the blender vortex. This additional blade 8c with blade arms 9c that are placed on top in the blade assembly 2, are to be bent in different angles. The top blades 8c having arms 9c work in conjunction with the rib 19 inside the jug. The rib 19 may divert the circulation and throw the ingredients in the blender jar to the centre of the jar to be sliced by the smaller blade arms 9c.

Reference is now made to FIGS. 1a-b, 2a-b and also to FIG. 3 showing a domestic or household type, in particular mobile, blender with a blender jar 1 as previously described, and with a corresponding motorized base unit 14. The blender jar 1 comprises at its lower side a coupling interface 15 which is adapted and configured to removeably or releasably couple the blender jar 1 and blender blade assembly 2 to the base unit 14.

The blender base unit 14 comprises a counter-interface 16 adapted and designed for being coupled to or for establishing a coupling engagement with the coupling interface 15 of the blender jar 1.

The blender base unit 14 further comprises a motor (not shown) for driving the blender blade assembly 2 in cases where the blender jar 1 is connected to the blender base unit 14. In more detail, a drive shaft connected to the drive motor can be coupled and latched to a corresponding shaft hole of the blender blade assembly 2 such that rotation of the drive motor can be transmitted to the blender blades 8a-c. The orientation of the drive shaft essentially corresponds to the orientation of the rotary axis 3 of the blender blade assembly 2, i.e. the drive shaft is tilted just as the rotary axis 3 of the blender blade assembly 2.

The counter-interface 16 of the blender base unit 14 and the coupling interface 15 of the blender jar 1 both are inclined with respect to the normal axis 5, provided that the blender, i.e. the blender base unit 14 and blender jar 1, is used in the ordinary operational orientation. Such an inclined configuration has the advantage that the blender jar 1 can be connected to the blender base unit 14 in a comparatively simple movement whilst connecting the twisted blender blade 2 to the twisted drive shaft of the motor.

As indicated in FIG. 3 by an arrow, connecting the blender jar 1 to the blender base unit 14 can be carried out in a downward movement at an angle from above, i.e. in a movement diagonally downwards. Removing the blender jar 1 from the blender base unit 14 requires a movement diagonally upwards. Respective movements of the blender jar 1 relative to the blender base unit 14 can be carried out by the user in a manual operation.

Using the inclined coupling interface 15 and counter-interface 16 has the advantage that the blender bladed 8a-c can be directly connected to the drive shaft of the motor without requiring complex gears or transmissions to adapt the orientation of the axis of rotation of the motor to the inclined orientation of the rotary axis 3 of the blender blade assembly 2.

### LIST OF REFERENCE NUMERALS

1 blender jar
2 blender blade assembly
3 rotary axis
4 bottom
5 normal axis
6 working surface
7 central axis
8a-c blender blade(s)
9a-c blade arm(s)
10 base section
11 wing section
12 winglet section
14 blender base unit
15 coupling interface
16 counter-interface
17 handle
18 lid
19 rib
γ tilt angle

1. A blender jar for a household type blender, the blender jar comprising:
a jar; and
a blender blade assembly rotatably mounted around a rotary axis at a bottom of the blender jar, wherein the rotary axis is tilted from a normal axis of a working surface upon which the blender jar is configured to operate in ordinary use, and wherein the bottom of the blender jar at which the blender blade assembly is positioned has a flat surface configuration.

2. The blender jar according to claim 1, wherein a tilt angle by which the rotary axis is tilted from the normal axis lies in the range from 5 degrees to 20 degrees.

3. The blender jar according to claim 1, wherein a central axis of inner walls of the blender jar and the rotary axis are tilted from each other by an acute angle.

4. (canceled)

5. (canceled)

6. The blender jar according to claim 1, wherein a blender blade of the blender blade assembly has a trough-shaped vertical cross section.

7. The blender jar according to claim 1, wherein a blender blade of the blender blade assembly has a curved shaped, flat blade arm.

8. The blender jar according to claim 1, wherein side walls of the blender jar are inclined relative to a axis of the blender jar, such that an axial cross section of the blender jar decreases towards the bottom of the blender jar.

9. The blender jar according to claim 1, further comprising a coupling interface configured to couple the blender jar and blender blade assembly to a motorized base unit, wherein the coupling interface is configured to be coupled to the motorized base unit from above at an angle tilted from the normal axis.

10. (canceled)

11. (canceled)

12. A blender of a household type, the blender comprising:
a blender jar comprising:
a jar, and
a blender blade assembly rotatably mounted around a rotary axis at a bottom of the blender jar, wherein the rotary axis is tilted from a normal axis of a working surface upon which the blender jar is configured to operate in ordinary use, and wherein the bottom of the blender jar at which the blender blade assembly is positioned has a flat surface configuration, and
a coupling interface; and
a blender base unit comprising:
a motor for driving a blender blade assembly of a blender jar; and
a coupling counter-interface configured to removeably receive the coupling interface of the blender jar.

13. The blender according to claim 12, wherein the coupling counter-interface is configured to removeably receive the coupling interface of the blender jar at an angle relative to the normal axis.

14. The blender according to claim 12, wherein a tilt angle by which the rotary axis is tilted from the normal axis lies in the range from 5 degrees to 20 degrees.

15. The blender according to claim 12, wherein a central axis of inner walls of the blender jar and the rotary axis are tilted from each other by an acute angle.

16. The blender according to claim 12, wherein side walls of the blender jar are inclined relative to a central axis of the blender jar, such that an axial cross section of the blender jar decreases towards the bottom of the blender jar.

17. The blender according to claim 12, wherein a blender blade of the blender blade assembly has a curved shaped, flat blade arm.

18. The blender according to claim 12, wherein the blender blade assembly comprises:
a first trough-shaped blade having a respective wing section angled away from the bottom of the blender jar at a first angle; and
a flat blade that extends parallel to the bottom of the blender jar below the wing section of the first trough-shaped blade.

19. The blender according to claim 18, wherein the blender blade assembly further comprises a second trough-shaped blade having a respective wing section angled away from the bottom of the blender jar at a second angle.

20. The blender according to claim 1, wherein the blender blade assembly comprises:
a first trough-shaped blade having a respective wing section angled away from the bottom of the blender jar at a first angle; and
a flat blade that extends parallel to the bottom of the blender jar below the wing section of the first trough-shaped blade.

21. The blender according to claim 20, wherein the blender blade assembly further comprises a second trough-shaped blade having a respective wing section angled away from the bottom of the blender jar at a second angle.
